(19) United States
(12) Patent Application Publication
(10) Pub. No.: US 2005/0177761 A1
(43) Pub. Date: Aug. 11, 2005

(54) Method for diagnosing an equipment to be controlled, diagnostic system, related intermediate server and communication module

(76) Inventor: Jean-Pierre Martiniere, Liffre (FR)

Correspondence Address: COHEN, PONTANI, LIEBERMAN & PAVANE, 551 FIFTH AVENUE, SUITE 1210, NEW YORK, NY, 10176, US

(21) Appl. No.: 10/510,429

(22) PCT Filed: Apr. 4, 2003
(86) PCT No.: PCT/FR03/01065

(30) Foreign Application Priority Data
Apr. 8, 2002 (FR) 0204371

(51) Int. Cl. G06F 11/00; G06F 15/173

(52) U.S. Cl. 714/4; 709/224

(57) ABSTRACT

The communications module (1) associated with the equipment (2) to be inspected reads operating data concerning the equipment (2) to be inspected and forwards the data to a remote server (3, 5a, 5b, . . . , 5n), and the remote server (3, 5a, 5b, . . . , 5n) makes a diagnosis on the basis of the received operating data. An intermediate server (3) can determine which from among a plurality of specialized assistance server (5a, 5b, . . . , 5n) is the server appropriate for the equipment (2) and can put the communications module (1) and the specialized assistance server (5a, 5b, . . . , 5n) appropriate for the equipment (2) into communication so that the communications module (1) can transmit the operating data concerning the equipment (2) thereto.

The present invention relates to a method of diagnosing equipment to be inspected, and to a diagnosis system, servers, and a communications module for implementing the method.

Various methods exist for diagnosing malfunctioning equipment, for example a motor vehicle.

A first method consists in consulting and analyzing vehicle operating data as collected, by a computer on board the vehicle, for example.

A second method consists in connecting an external diagnosis appliance to an inspection socket of the vehicle. The appliance reads vehicle operating data and performs diagnosis on the basis of said data.

The first method can be implemented simply by a user of the vehicle, but diagnosis is rudimentary and turns out to provide low performance. The second method provides higher performance but is more complex to put into operation, since it generally requires a specialized repair service equipped with the diagnosis appliance.

Document WO 97/15009 discloses a method of diagnosing equipment to be inspected in which a communications module associated with the equipment to be inspected, reads operating data of the equipment to be inspected and forwards the data to a remote server, and the remote server performs diagnosis on the basis of the received operating data.

The diagnosis operation is triggered locally by the communications module and it is executed by the remote server. The user therefore does not necessarily need to visit a repair service. Such a method thus makes it simple for the user to obtain diagnosis concerning that user's equipment.

The present invention seeks to further improve that method of diagnosis so as to apply it to different collections of equipment, for example to motor vehicles manufactured by different manufacturers.

To this end, the invention provides a method of diagnosing an equipment to be inspected, in which a communications module associated with the equipment to be inspected reads operating data relating to the equipment to be inspected and forwards the data to a remote server, and the remote server performs a diagnosis on the basis of the operating data it receives, the method being characterized by the fact that:
an intermediate server determines which from among a plurality of specialized assistance servers is the server that is appropriate for the equipment, and puts the communications module into communication with the specialized assistance server that is adapted to the equipment; and
the communications module transmits the operating data concerning the equipment to the specialized assistance server which performs the diagnosis.

Each specialized assistance server is suitable for performing diagnosis on a predefined collection of equipment, for example all of the vehicles from a given motor manufacturer. The communications module is switched to the specialist assistance server corresponding to the equipment in centralized manner by the intermediate server. The communications module can thus obtain an improved diagnosis remotely in simple manner.

Preferably, an adjustment step is provided during which the remote server transmits adjustment orders for repairing the equipment to the equipment via the communications module.

This makes it possible for the equipment to be repaired remotely by the server.

The communications module may also read a distinctive characteristic of at least one element of the equipment, for example the name of the manufacturer or the serial number of a part of the equipment or of the equipment itself, and forwards the characteristic to the remote server. Such centralizing of information towards the remote server can facilitate the recall operations that equipment manufacturers need to launch when they detect a manufacturing detect that applies to a given collection of equipment. To return to this example, the serial number of the equipment or of the part as transmitted by the communications module to the server enables the server to determine whether the equipment in question is considered as being liable to present a manufacturing defect.

The invention also provides a system for diagnosing equipment to be inspected, for implementing the above-defined method, the system comprising a diagnosis server and a communications module associated with the equipment to be inspected, which server and module are connected to each other via a communications network, the communications module being arranged to transmit operating data concerning the equipment to the server, and the server being arranged to make a diagnosis on the basis of the operating data concerning the equipment, the system being characterized in that there are provided a plurality of specialized assistance servers suitable for making diagnoses and an intermediate server arranged to determine which from among the plurality of specialized assistance servers is the server appropriate for the equipment, and suitable for putting the communications module into communication with the appropriate specialized assistance server in order to cause a diagnosis to be made relating to the equipment.

The invention also provides an intermediate server for implementing the above-defined method, the server comprising receiver means for receiving a diagnosis request relating to equipment to be inspected, the server comprising means for determining which from among a plurality of specialized assistance servers is the server appropriate for an equipment to be inspected, and also comprising means for putting said communications module into communication with said appropriate specialized assistance server.

The invention also provides a communications module for implementing the above-defined method, the module comprising collector means arranged to read operating data relating to an equipment to be inspected and means for sending the operating data to a remote server, the module being characterized in that it is provided with means for detecting an emergency event relating to the equipment to be inspected and then, on detecting such an emergency event, for making a priority connection with a “black box” server and transmitting thereto a stream of data conveying data relating to the equipment to be inspected.

Finally, the invention provides a “black box” server comprising means for receiving a data stream conveying data relating to an equipment to be inspected, and means for storing said data in association with information relating to its time of reception.

The invention will be better understood on reading the following description of a particular implementation of the diagnosis method, of the diagnosis system, of the communications module, and of the servers of the invention, given with reference to the accompanying drawings, in which:

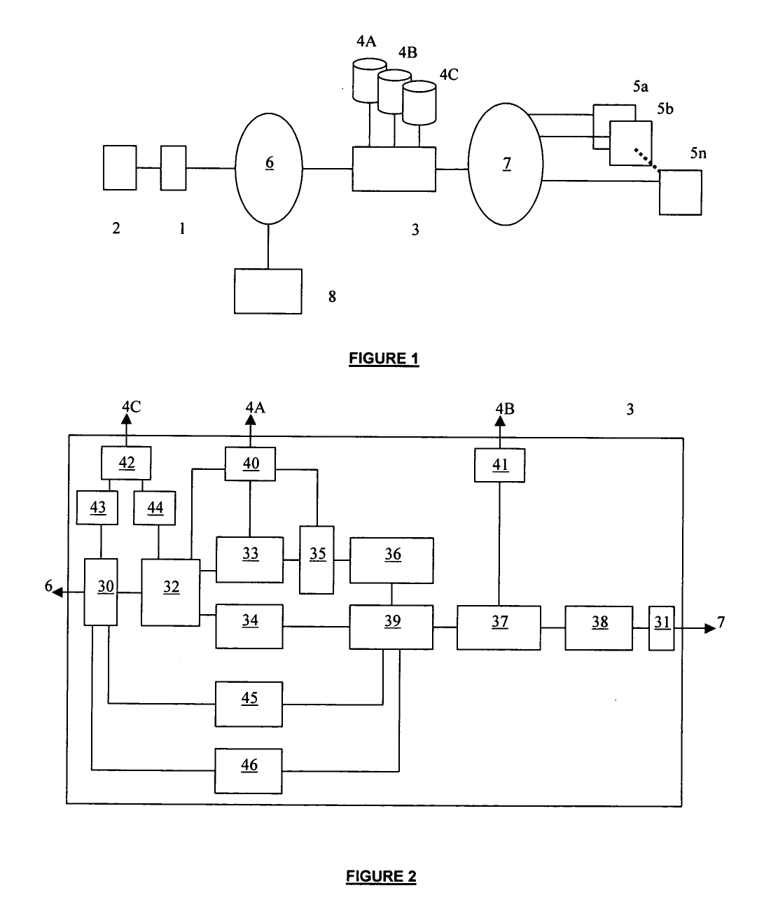

FIG. 1 is a diagram of the diagnosis system;

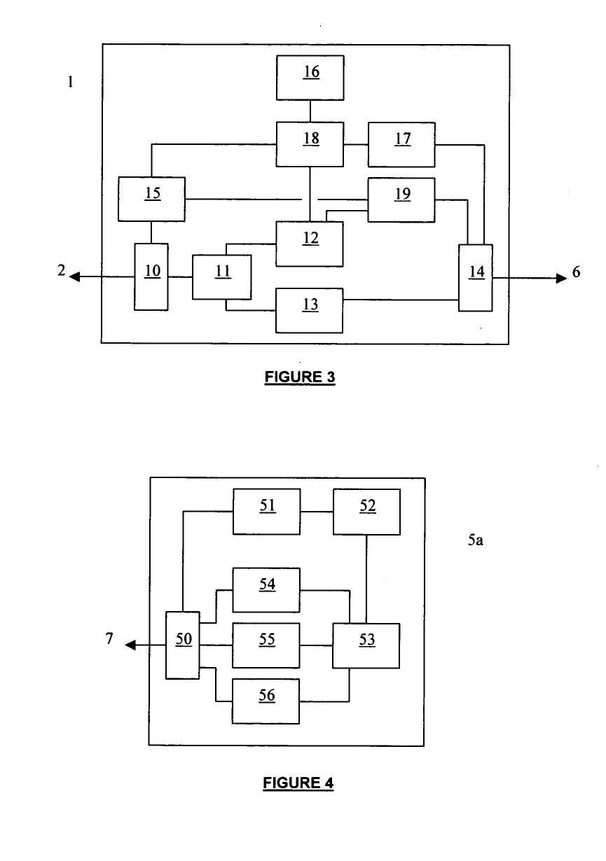

FIG. 2 is a functional block diagram of the intermediate server of FIG. 1;

FIG. 3 is a functional block diagram of the communications module of FIG. 1;

FIG. 4 is a functional block diagram of the specialized assistance server; and

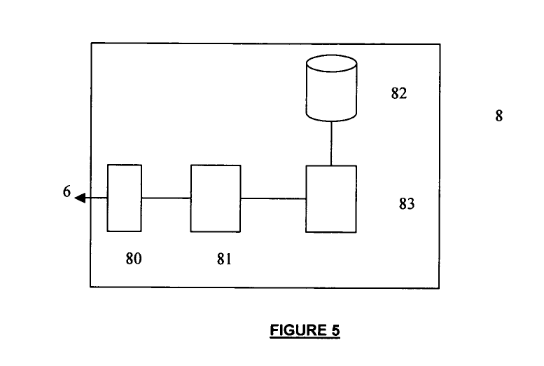

FIG. 5 is a functional block diagram of a black box server of FIG. 1.

FIG. 1 shows the diagnosis system of the invention comprising a communications module 1 associated with equipment 2 to be inspected, an intermediate server 3 associated with a user database 4A, with a specialized assistance server database 4B, and with a database 4C containing diagnosis applications and adjustment applications, a “black box” server 8, and a plurality of specialized assistance servers 5a, 5b, . . . , 5n. For reasons of clarity, only one communications module 1 and only one associated piece of equipment 2 are shown. Nevertheless, the system preferably comprises a plurality of communications modules 1 each associated with one, or preferably more than one, piece of equipment 2. In FIG. 1, there is also shown a first communications network 6, in this case a GSM cellular network, connecting the communications module 1 to the intermediate server 3 and to the “black box” server 8, and a second communications network 7, in this case a private network, connecting the intermediate server 3 to the specialized assistance servers 5a, 5b, . . . , 5n. Naturally, it would be possible to use other communications network 6 and 7. By way of non-limiting example, the network 6 could be an ADSL, a GPRS, or a UMTS network.

For each user, the user database 4A contains a personal profile of the user, associated with:
a profile of the communications module 1; and
at least one profile of an equipment 2 to be inspected.

The personal profile contains data identifying the user (name, or identifier, and confidential code).

The profile of the communications module 1 contains the characteristics of the communications module 1, classified in the present case in the following fields: “type”, “model”, “parameters”, and “identifier”. The “type” field specifies the nature of the communications module 1. Specifically, when the communications module 1 comprises a GSM cellphone and a pocket computer or “PocketPC” that are connected together, the “type” field contains the mention “GSM telephone and PocketPC”. The “model” field is the brand and possibly also the reference or model of the manufacturer of the communications module. The “parameter” field contains other useful information about the communications module, such as the telephone call number of the communications module and additional options available to the communications module, for example the GPS (global positioning system) option. The “identifier” field contains an identifier given to the communications module 1, e.g. comprising its telephone number, or data associated with the SIM card of the communications module 1.

The profile of the equipment 2 contains the characteristics of said equipment 2, classified in fields similar to those of the profile of the communications module 1, namely: “type”; “model”; “parameters”; and “identifier”. In the particular description described, where the piece of equipment 2 to be inspected is a motor vehicle, the “type” field contains the mention “motor vehicle”, the “model” field gives the brand and the model of the vehicle manufacturer, e.g. “brand X, model Y”, and the “parameters” field contains useful information about the vehicle such as its registration number, the date it was first put on the road, etc. In addition, the equipment profile 2 contains an “assistance level” containing an assistance level for the piece of equipment 2, a “billing” field containing the method of billing for assistance performed on the equipment 2, and a “repair service” field containing data identifying a repair service. The assistance level defines conditions under which the user desires to obtain assistance for the equipment 2. In the particular example being described, two assistance levels A and B are on offer. Assistance level A provides assistance on demand, when needed, and assistance level B provides not only assistance on demand, but also regular assistance, e.g. once a month. The billing method specifies whether the user desires to be billed for assistance interventions on the equipment 2 at a flat rate, per intervention, or on a time basis. Finally, the repair service identification data contains the name and details (telephone number, postal address, etc.) of a repair service preferred by the user for the particular piece of equipment 2.

The specialized assistance server database 4B contains, for each server, all of the information required for determining the equipment for which each server is competent.

The database 4C contains diagnosis applications and adjustment applications adapted to different kinds of equipment 2.

With reference to FIG. 2, the intermediate server 3 comprises a block 30 for connection to the network 6, a block 31 for connection to the network 7, a block 40 giving access to the database 4A, a block 41 giving access to the database 4B, and a block 42 giving access to the database 4C. A server/user interface 32 is interposed between firstly the block 30 for connection to the network 6 and secondly a block 33 for receiving diagnosis requests and operating data concerning an equipment 2, a block 34 for sending information to the users of equipment 2, and a block 44 for sending diagnosis applications and adjustment applications to communications modules 1.

The server/user interface 32 manages communication between the server 3 and each user. The module 32 serves in particular to enable each user to register with the server 3, to declare thereto a communications module 1 and one or more pieces of equipment 2 to be inspected in association with said communications module 1, and to request a diagnosis application and an adjustment application.

The blocks 40-42 giving access to the various databases 4A, 4B, 4C serve to extract, to enter, to delete, and/or to modify information contained in the databases 4A, 4B, and 4C. The block 42 giving access to the database 4C is connected to a block 43 for acquiring diagnosis applications and adjustment applications, itself connected to the block 30 for connection to the network 6, and also to a block 44 for sending diagnosis applications and adjustment applications to the communications modules 1, itself being connected to the server/user interface 32. The acquisition block 43 serves to recover diagnosis applications and adjustment applications for particular kinds of equipment 2 from manufacturers' servers (not shown) in order to record them in the database 4C. The sending block 44 serves to send diagnosis applications and adjustment applications to the communications modules 1. The block 40 giving access to the database 4A is connected to the server/user interface 32.

The intermediate server 3 further comprises a diagnosis module 36 arranged to perform diagnoses on the basis of the operating data concerning pieces of equipment 2 as received by the receiver block 33.

A control module 39 is interposed between firstly the diagnosis module 36 and secondly a connection setup module 38, the module 34 for sending information to users, an adjustment module 45, and a module 46 for sending requests for contacting repair services. The control module 39 serves, as a function of the result of each diagnosis, to order various actions, as explained below when describing the method. The various circumstances are as follows:
i) diagnosis enables a malfunction to be detected that can be repaired remotely by the server 3;
ii) diagnosis enables a malfunction to be detected that can be repaired on site by the user;
iii) diagnosis enables a malfunction to be detected which requires the intervention of a repair service for its repair;
iv) diagnosis enables a malfunction to be detected for which remote repair is possible, but requires adjustment capacities greater than those of the server 3; and
v) diagnosis has not enabled any malfunction to be detected.

The adjustment module 45 connected to the block 30 for connection to the network 6 serves in circumstance i) to send adjustment instructions to the piece of equipment 2 under inspection via the communications module 1.

The sender module 34 serves to send a variety of information to each user as a function of the result of the diagnosis, as explained below when describing the method. This information may comprise, in particular, all of the information that is useful to enable a user to repair the equipment 2 in circumstance ii), the information that repair of the equipment 2 requires the intervention of a repair service in circumstance iii), or indeed information stating that it is appropriate to put the communications module 1 into communication with a specialized application server 5a, 5b, . . . , 5n in circumstances iv) and v). In circumstances iv) and v), the block 39 serves to trigger putting the module 1 into communication with a specialized assistance server.

In circumstance iii), the sender module 46 serves, to send a request to set up a connection with a repair service, as explained below when describing the method.

A module 37 for selecting a specialized assistance server 5a, 5b, . . . , 5n is interposed between the control module 39 and the connection setup module 38. This selection module 37, which is connected to the diagnosis module 36 and to the block 41 giving access to the database 4B, serves to determine which assistance server from among the specialist assistance servers 5a, 5b, . . . , 5n is appropriate for a given piece of equipment 2, and to select said server in order to put the communications module associated with the equipment 2 into communication with the selected specialist server.

The connection setup module 38 connected to the selection module 37 and to the block 31 for connection to the network 7 serves to put a specialized assistance server 5a, 5b, . . . , 5n into communication with a communications module 1, in order to enable the specialist server 5a, 5b, . . . , 5n to establish a diagnosis or to download a diagnosis application or an adjustment application from the specialist server 5a, 5b, . . . , 5n to the communications module 1.

An identification module 35 is connected to the receiver block 33, to the diagnosis module 36, and to the block giving access to the user database 4A. On receiving a diagnosis request this identification block 35 serves to identify the communications module 1 that issued the request the piece of equipment 2 about which the request is being made.

With reference to FIG. 3, the communications module 1, in this case constituted by a pocket computer associated with a GSM telephone, comprises a block 10 for connection to an equipment 2, a block 14 for connection to the network 6, a block 11 for collecting operating data from the equipment 2, and a diagnosis block 12.

The connection block 10 serves to connect the communications module 1 to the equipment 2, in this case via a BlueTooth connection. Nevertheless, provision could be made for any other type of connection, by radio or wire, between the communications module 1 and the equipment 2.

The collection block 11 connected to the connection block 10 and to the diagnosis block 12 serves to read operating data concerning the equipment 2. Operating data is collected and sent to the server 3 either “on demand” or else “automatically”. The “on demand” mode consists in collecting operating data relating to the equipment 2 and sending it to the server 3 when required, at the request of the user, generally when the equipment 2 presents a malfunction which the module 1 has not been able to repair locally. “Automatic” mode consists in collecting operating data relating to the equipment 2 and sending it to the server 3 in automatic and regular manner for continuous maintenance of the equipment 2. When the assistance level of the equipment 2 is level A, the communications module 1 can send operating data concerning the equipment 2 in “on demand” mode only, whereas when the assistance level is level B, operating data can be sent to the server 3 not only in “on demand” mode, but also in “automatic” mode.

The diagnosis block 12 includes a diagnosis application for performing diagnoses on the equipment 3 on the basis of operating data read by the collection block 11.

A control block 18 is interposed between firstly the diagnosis block 12 and secondly an adjustment block 15, a block 16 for notifying information to a user, and a block 17 for giving access to the intermediate server 3. The control block 18 serves to control various actions, as a function of the result of each diagnosis, as explained below when describing the method. The various circumstances that can be envisaged are analogous to circumstances i) to v) mentioned above, namely:
i′) diagnosis has enabled a malfunction to be detected that can be repaired locally by the module 1;
ii′) diagnosis has enabled a malfunction to be detected that can be repaired on site by the user;
iii′) diagnosis has enabled a malfunction to be detected which requires the intervention of a repair service for its repair;
iv′) diagnosis has enabled a malfunction to be detected for which remote repair is possible but requires adjustment capacities that are greater than those of the module 1; and
v′) diagnosis has not enabled any malfunction to be detected.

The adjustment block 15 serves to issue adjustment orders to the equipment 2 in circumstance i′).

The information notification block 16 serves to cause a variety of information to be displayed as a function of the result of the diagnosis, as explained below when describing the method. This information may include, in particular: all information that is useful in enabling a user to repair the equipment 2 in circumstance ii′); information to the effect that repair of the equipment 2 requires the intervention of a repair service in circumstance iii′); or indeed information stating that it is appropriate to put the communications module 1 into communication with the intermediate server 3 in circumstances iv′) and v′). In both circumstances iv′) and v′), the block 18 serves to trigger connection of the module 1 to the intermediate server 3.

The block 17 giving access to the intermediate server 3 and connected to the block 14 for connection to the network 6 serves to connect the module 1 to the intermediate server 3 and to send data to the intermediate server 3, in particular the operating data concerning the equipment 2.

An application acquisition block 19 is also provided interposed between the connection block 14 and both the diagnosis block 12 and the adjustment block 15, and it serves to recover diagnosis applications and adjustment applications.

A “black box” block 13 is interposed between the collection block 11 and the block 14 for connection to the network 6. It serves to monitor the operating data concerning the equipment 2 and to detect any emergency event such as, for example: sudden braking of the vehicle 2, or a major rise in the temperature of a given circuit. If an emergency event is detected, the block 13 is arranged to order the following actions:
immediate collection of a maximum amount of data relating to the equipment 2;
priority connection of the communications module 1 to the “black box” server 8; and
sending a stream of data to the “black box” server 8 conveying identification data and other data relating to the equipment 2. In this case, the data relating to the equipment 2 comprises the operating data of the equipment 2. In a variant, this data could also comprise data relating to the environment of the equipment 2, such as, for example, when the equipment 2 is a motor vehicle, picture data from a camera situated in the vehicle 2 and monitoring the road in front of the vehicle 2.

In the particular example of this description, the communications module 1 has only one data transmission channel. When the term “priority” is used herein to describe a connection, that means that if a call is already in progress with a third party via the transmission channel, then the communications module 1 automatically interrupts the call and connects to the server via the transmission channel. If the communications module 1 possesses a plurality of data transmission channels, then a priority connection would consist in using the maximum number of available transmission channels for transmitting data relating to the equipment 2.

The pocket computer of the module 1 includes the blocks 10-13 and 15-19 while the cell telephone of the module 1 is represented by the block 14.

The communications module 1 further comprises a man-machine interface (not shown) comprising a screen, a keypad, and track ball. The screen may be a touch-sensitive screen, and the track ball may be replaced by a touch-sensitive pad.

The communications module 1 may include a plurality of diagnosis or adjustment applications suitable respectively for performing diagnoses or for performing adjustments, for different pieces of equipment 2.

With reference to FIG. 4, each specialist assistance server 5a, . . . , 5n comprises a block 50 for connection to the network 7, an interface 51 between the specialist server 5a, . . . , 5n and the intermediate server 3 (or communications module 1), and a diagnosis module 52.

The interface 51 connected to the block 50 for connection to the network 7 serves to control the call between the specialist server 5a, . . . , 5n and the intermediate server 3 or the communications module 1.

The diagnosis module 52 serves to receive operating data concerning equipment 2 via the interface 51, and to establish diagnoses concerning pieces of equipment 2 on the basis of the operating data.

A control module 53 is interposed between firstly the diagnosis module 52 and secondly an adjustment module 54, a module 55 for sending information to users, and a module 56 for sending requests to make contact. The control module 53 serves to trigger various actions depending on the result of each diagnosis, as explained below when describing the method. The various circumstances that can be envisaged are analogous to the circumstances i), ii), iii), and v) mentioned above, namely:
i″) diagnosis serves to detect a malfunction that can be repaired remotely by the specialist server 5a, . . . , 5n;
ii″) diagnosis enables a malfunction to be detected that can be repaired on site by the user;
iii″) diagnosis enables a malfunction to be detected that requires the intervention of a repair service for its repair; and
iv″) diagnosis does not enable any malfunction to be detected.

The adjustment module 54 serves to send adjustment orders to the equipment 2 via the communications module 1 in circumstance i″).

The sender module 55 serves to send a variety of user information to each communications module 1, depending on the result of the diagnosis, and as explained below when describing the method. This information may comprise, in particular, all information that is useful in enabling the user to repair the equipment 2 in circumstance ii″), or information to the effect that repair of the equipment 2 requires the intervention of a repair service in circumstances iii″) and iv″). In these two circumstances iii″) and iv″), the sender module 56 serves to send a request to make contact with a repair service, as explained below when describing the method.

The specialist assistance server 5a, . . . , 5n may also include means for sending diagnosis applications and adjustment applications to the communications modules 1.

With reference to FIG. 5, the “black box” server 8 comprises a module 80 for connection to the network 6, a module 81 for receiving data relating to pieces of equipment 2, a database 82, and a recording module 83. If an emergency event concerning an equipment 2 is detected by the associated communications module 1, it sends a stream of data to the “black box” server 8 including identification data and data relating to the equipment 2. The module 81 receives this data, and the module 83 records it in the database 82, associating therewith a time stamp, specifically the date and the time at which the data was received.

The method of diagnosing an equipment 2 for inspection is described below. It is recalled that in the particular example being described, the piece of equipment 2 is a motor vehicle.

In a prior step of registration, the user of the communications module 1 registers with the server 3, in this case using the communications module 1. Nevertheless, this registration could be performed from any communications terminal. During this step, the user declares to the server 3 the equipment 2 to be inspected and its communications module 1, and transmits to the server all useful characteristics of the equipment 2 and the communications module 1. The intermediate server 3 associates a personal profile with the user. In addition, an equipment profile and a communications module profile are associated respectively with the equipment 2 and the communications module 1. The personal profile of the user contains data identifying the user, i.e. in this case a name and a confidential code. The characteristics of the equipment 2 and of the communications module 1 are classified in the various fields described above. In the particular example being described, the profile of the equipment 2 contains:
in the “type” field: a mention that the equipment 3 is a motor vehicle;
in the “model” field: the brand and the model of the vehicle manufacturer;
in the “parameters” field: the registration number and the date the vehicle was first put on the road;
in the “assistance level” field: the selected assistance level, in this case level A;
in the “billing” field: the method of billing, in this case per intervention; and
in the “identifier” field: an identifier allocated by the server 3 to the equipment 2.

The profile of the communications module 1 contains the following:
in the “type” field: the nature of the communications module 1, in this case a pocket computer associated with a cellphone;
in the “model” field: the brand and the model of the manufacturer of the pocket computer and the cell-phone;
in the “parameters” field: the telephone call number of the cellphone; and
in the “identifier” field: an identifier allocated by the server 3 to the communications module 1.

The identifier of the equipment 2 and the identifier of the communications module 1 are both sent to the communications module 1 and serve to identify the equipment 2 and the communications module 1 in unique manner. The server 3 records the profile of the communications module 1 and the profile of the equipment 2 in the user database 4A, and associates them with the personal profile of the user.

On request of the communications module 1, the intermediate server 3 extracts a diagnosis application and an adjustment application suitable for the equipment 2 from the database 4C and transmits the applications to the communications module 1.

There follows a more detailed description of an operation of diagnosing and repairing the equipment 2.

There are provided three levels I, II, and III of diagnosis and adjustment, or if adjustment is not possible, of information notification, which levels are designed to be implemented one after the other by the communications module 1, by the intermediate server 3, and by the specialized assistance server 5a, . . . , 5n. At each level N, a diagnosis is performed. Depending on the results of the diagnosis, an assistance intervention is triggered at level N, or a call is made to level N+1 to perform a more difficult diagnosis. Depending on circumstances, the assistance intervention consists either in sending adjustment orders to the equipment 2, or in informing the user that the repair requires the intervention of a repair service, or in providing the user with all the information that is useful to enable the user to repair the malfunction. The various levels I, II, and III are described below.

Level I

On user request, the communications module 1 collects operating data concerning the equipment 2 and performs local diagnosis on the basis of the data.

If the module 1 detects a malfunction that can be repaired locally (circumstance i′)), it sends adjustment orders to the equipment 2. The adjustment orders enable certain operating parameters of the vehicle to be adjusted, or possibly serves to activate a backup circuit for replacing a faulty circuit.

If the module 1 detects a malfunction that can be repaired by the user (circumstance ii′)), it displays all of the information that is useful for enabling the user to repair the vehicle.

If the module 1 detects a malfunction requiring the intervention of a repair service (circumstance iii′)), it displays information to the effect that repairing the malfunction requires the intervention of a repair service.

If the module 1 does not have sufficient adjustment capacity to repair the malfunction (circumstance iv′)), or if it does not detect any malfunction (circumstance v′)), then the communications module 1 displays information to the effect that it is necessary to call a remote server having diagnosis and adjustment capacities that are greater than those of the module 1.

In these last two circumstances iv′) and v′), the communications module 1 makes a connection to the intermediate server 3, possibly after receiving acceptance from the user, collects the operating data concerning the equipment 2, and sends the data to the server 3 together with a diagnosis request containing:
the identification data of the user;
the identifiers of the communications module 1 and of the equipment 2;
a mention to the effect that a diagnosis is required for the equipment 2; and
in this case, information concerning the location of the equipment 2.
   Level II

The intermediate server 3 verifies the validity of the user identification data and extracts the profiles of equipment 2 and of the communications module 1 from the database 4A, using their respective identifiers. If the user identification data is correct, the server 3 performs diagnosis of the equipment 2 on the basis of the operating data it has received. As a function of the results of this diagnosis, the server 3 triggers various different interventions.

If the server 3 detects a malfunction that can be repaired remotely (circumstance i)), it sends adjustment orders to the equipment 2 and the communications module 1 via the network 6. These adjustment orders enable certain operating parameters of the equipment 2 to be adjusted or a backup circuit to be activated instead of a faulty circuit. In parallel, the server 3 sends information to the communications module 1 concerning the nature of the malfunction and an indication to the effect that the malfunction has been repaired remotely, and the module 1 displays this information.

If the server 3 detects a malfunction that can be repaired by the user (circumstance ii)), it sends to the communications module 1 all of the information that is useful for enabling the user to repair the equipment 2, and the communications module 1 displays this information.

If the server 3 detects a malfunction requiring intervention from a repair service (circumstance iii)), it sends to the communications module 1 information to the effect that repair of the malfunction requires the intervention of a repair service, and the communications module 1 displays this information.

If the server 3 does not have sufficient adjustment capacity to repair the detected malfunction (circumstance iv)), or if it does not detect any malfunction (circumstance v)), the server 3 sends to the communications module 1 information to the effect that it is necessary to call on a specialized assistance server 5a, . . . , 5n having diagnosis and adjustment capacities that are greater than those of the server 3, and the communications module 1 displays this information. The intermediate server 3 optionally invites the user to confirm acceptance of communication being established between the communications module 1 and a specialized assistance server 5a, . . . , 5n.

On the basis of the profile of the equipment 2, the server 3 determines which server among the plurality of specialized assistance servers 5a, . . . , 5n is appropriate for the equipment 2, i.e. is competent to perform diagnosis of the equipment 2. Specifically, in this case, the specialized assistance server suitable for the equipment 2 is the server 5a. The intermediate server 3 then puts the communications module 1 into communication with the specialist assistance server 5a. The server 3 forwards the operating data concerning the equipment 2 to the assistance server 5a. In other words, the operating data concerning the equipment 2 is transmitted from the communications module 1 to the specialized server 5a via the server 3. It would also be possible to envisage the communications module 1 transmitting operating data concerning the equipment 2 directly to the server 5a after they have been put into communication with each other.

Level III

The specialized server 5a performs a diagnosis of the equipment 2 on the basis of the operating data it has received.

If the server 5a detects a malfunction that can be repaired remotely (circumstance i″)), it sends adjustment orders to the equipment 2 via the networks 7 and 6 and the communications module 1. These adjustment orders enable certain operating parameters of the equipment 2 to be adjusted or they enable a backup circuit to be activated to take the place of a faulty circuit. In parallel, the specialized server 5a sends information to the communications module 1 concerning the detected malfunction and information to the effect that the malfunction has been repaired remotely. The communications module 1 displays this information.

If the server 5a detects a malfunction that can be repaired by the user (circumstance ii″)), it sends to the communications module 1 all of the information that is useful to enable the user to repair the equipment 2, and the communication module 1 displays this information.

If the server 5a detects a malfunction requiring intervention from a repair service (circumstance iii″)), it sends information to the communications module 1 to the effect that repair of the malfunction requires the intervention of a repair service, and the communications module 1 displays this information.

If the server 5a does not have sufficient adjustment capacity to repair the detected malfunction (circumstance iv″)), or if it does not detect any malfunction (circumstance v″)), then the server 5a transmits information to the communications module 1 to the effect that it is necessary to call on a repair service, and the communications module 1 displays this information.

In the event of a malfunction requiring the intervention of a repair service being detected at level II by the intermediate server 3 or at level III by the specialized server 5a, then the server in question (3 or 5a) sends a request to the repair service to make contact and containing data identifying the user of the equipment 2, the address of the communications module 1 on the network 6 (i.e. the cellphone call number of the communications module 1), and information relating to the malfunction. The repair service is either the service that appears in the profile for the equipment 2, or else the service that is closest to the equipment 2, depending on the severity of the malfunction. After receiving the request, the repair service makes contact with the user via the network 6 in order to agree a rendezvous. The server in question (3 or 5a) may send this request to make contact to the repair service only after acceptance by the user. In a variant, it could be envisaged that the server in question (3 or 5a) sends the telephone number of the selected repair service to the communications module 1.

In the event of the severity of the malfunction detected at any one of the levels I, II, III indicating that use of the equipment 2 is dangerous, the communications module 1 displays a warning message in order to warn the user. If the malfunction is detected at level II or III, then the warning message is initially transmitted from the intermediate server 3 or the specialized server 5a, . . . , 5n to the communications module 1 in order to be displayed thereby.

The various operations performed by the server 3 and by the specialized assistance server 5a are billed in centralized manner by the intermediate server 3, using the method of billing that has been selected for the equipment 2. If the subscription of a subscriber does not give access to the services provided by the specialized assistance servers, the user can nevertheless access them on demand, in return for payment.

Furthermore, the communications module 1 continuously monitors the operating data relating to the equipment 2. On detecting an emergency event relating to the equipment 2, e.g. on detecting a sudden increase in a given circuit or sudden braking, the communications module 1 makes a priority connection to the “black box” server 8, collects a maximum amount of operating data concerning the equipment 2, and transmits a data stream to the server 8 conveying the identifier and the operating data concerning the equipment 2. The server 8 records the identifier and the operating data relating to the equipment 2, and associates therewith the time and the date of reception of said data. The communications module 1 can authenticate the data transmitted to the “black box” server by encrypting the data using an authentication algorithm.

When the equipment 2 is the subject of regular maintenance, it sends a diagnosis request to the intermediate server 3 regularly and automatically. In a variant, the intermediate server 3 could itself undertake remote reading of the operating data concerning the equipment 2 by making regular calls to the communications module 1.

The equipment 2 may constitute an emergency vehicle, for example an ambulance including medical monitoring appliances connected to the communications module 1. Under such circumstances, the intermediate server 3 acts in centralized manner to direct a fleet of emergency vehicles to various emergency centers, such as hospitals, and puts the communications modules 1 of the emergency vehicles and specialized assistance servers 5a, 5b, . . . , 5n associated with respective different destination emergency centers. In the example of an ambulance transporting a patient, the communications module 1 collects operating data delivered by the medical monitoring appliances, corresponding to vital data concerning the patient and transmits this data to the specialized server 5a, 5b, . . . , 5n. The server can thus monitor remotely the state of the patient present in the ambulance and can perform diagnoses concerning the patient and possibly provide medical assistance to the ambulance by sending information to the communications module 1.

The “black box” server 8 may be integrated in the intermediate server 3.

Communication between the communications module 1 and the intermediate server 3, or a specialized server 5a, 5b, . . . , 5n may be in text and/or in voice form.

In the description given above, the communications module 1 recovers directly the diagnosis application and the adjustment application that are appropriate for the equipment 2 to be monitored. The user could also recover those applications on some other device, such as a personal computer (PC), and subsequently load them into the communications module 1 from that device.

In the above description, a complete diagnosis is performed at each level I, II, and III. In a variant, and for reasons of speed, when a diagnosis has already been performed at level N, the diagnosis performed at level N+1 could be restricted to additional diagnosis only.

The “pocket computer” function and the function of making a connection between the communications module 1 and the communications network 6 could be integrated in a single device, for example a pocket computer integrating a UMTS function.

The communications module 1 could also be integrated in the equipment 2. To return to the example of a motor vehicle 2, the communications module 1 could be integrated in the on-board computer of the vehicle.

It is recalled that the communications module 1 may be associated with different pieces of equipment 2.

In the above description, the communications module 1 reads operating data concerning the equipment 2 and forwards it to a remote server 3 or 5a, . . . , 5n in order to make a diagnosis. In a variant, the communications module could also read one or more distinctive characteristics relating to an element of the equipment or to the equipment itself and forward said characteristic(s) to the remote server 3 or 5a, . . . , 5n. As non-limiting examples of distinctive characteristics, mention can be made of the name of the manufacturer or the serial number of a part of the equipment 2 (for example the serial number of the gearbox of a motor vehicle) or of the equipment 2 itself. When a manufacturer has detected a manufacturing defect that is liable to concern pieces of equipment, the intermediate server 3 or the specialized server 5a, . . . , 5n determines which pieces of equipment in a given fleet or other collection are liable to be affected by the manufacturing defect, because of the centralization of the distinctive characteristics of elements of the pieces of equipment 2 or of the pieces of equipment 2 themselves in the collection in question. The server 3 or 5a, . . . , 5n can then easily warn the users of the pieces of equipment concerned by sending warning messages to the associated communications modules 1, and can request them to take the pieces of equipment to the appropriate manufacturer or repair service to undertake a repair or an exchange.

1. A method of diagnosing an equipment (2) to be inspected, in which a communications module (1) associated with the equipment (2) to be inspected reads operating data relating to the equipment (2) to be inspected and forwards the data to a remote server (3, 5a, 5b, . . . , 5n), and the remote server (3, 5a, 5b, . . . , 5n) performs a diagnosis on the basis of the operating data it receives, the method being characterized by the fact that:
an intermediate server (3) determines which from amongst a plurality of specialized assistance servers (5a, 5b, . . . , 5n) is the server that is appropriate for the equipment (2), and puts the communications module (1) into communication with the specialized assistance server (5a, 5b, . . . , 5n) that is adapted to the equipment (2); and
the communications module (1) transmits the operating data concerning the equipment (2) to the specialized assistance server which performs the diagnosis.

2. A method according to claim 1, in which an adjustment step is provided during which the remote server (3, 5a, 5b, . . . , 5n) transmits adjustment orders for repairing the equipment (2) to the equipment (2) via the communications module (1).

3. A method according to claim 1, in which a local diagnosis step is provided that is performed by the communications module (1), and that is followed, when the equipment (2) can be repaired by the communications module (1), by an adjustment step during which the communications module (1) transmits adjustment orders to the equipment (2).

4. A method according to claim 2, in which, when the equipment (2) cannot be repaired by the communications module (1), an information notification step is provided during which the communications module (1) provides a user either with information to enable the user to repair the malfunction, or information to the effect that repair of the malfunction requires the intervention of a repair service.

5-6. (canceled)

7. A method according to claim 4, in which there are provided three levels of diagnosis and adjustment, or if adjustment is not possible, of information notification, the levels being designed to be implemented one after another respectively by the communications module (1), by the intermediate server (3), and by the specialized assistance server (5a, . . . , 5n) and
in which, after performing a diagnosis at level N, another diagnosis is performed at the next higher level N+1 in the event of neither of the two steps of adjustment or information notification being performed at level N.

8-13. (canceled)

14. A method according to claim 1, in which, on detecting an emergency event relating to the equipment (2) to be inspected, the communications module (1) makes a priority connection to a “black box” server (8) and transmits data relating to the equipment (2) to be inspected thereto.

15. A method according to claim 1, in which the communications module reads a distinctive characteristic of at least one element of the equipment and transmits the characteristics to the remote server.

16. A diagnosis system for diagnosing an equipment to be inspected, for implementing the method of claim 1, the system comprising a diagnosis server (3, 5a, 5b, . . . , 5n) and a communications module (1) associated with the equipment (2) to be inspected, which server and module are connected to each other via a communications network (6, 7), the communications module (1) being arranged to transmit operating data concerning the equipment (2) to the server (3, 5a, 5b, . . . , 5n), and the server (3, 5a, 5b, . . . , 5n) being arranged to make a diagnosis on the basis of the operating data concerning the equipment (2), the system being characterized in that there are provided a plurality of specialized assistance servers (5a, 5b, . . . , 5n) suitable for making diagnoses and an intermediate server (3) arranged to determine which from amongst the plurality of specialized assistance servers (5a, 5b, . . . , 5n) is the server appropriate for the equipment (2), and suitable for putting the communications module (1) into communication with the appropriate specialized assistance server in order to cause a diagnosis to be made relating to the equipment (2).

17-18. (canceled)

19. A system according to claim 16, in which, when the equipment to be inspected is an emergency vehicle, the intermediate server (3) is arranged to direct the emergency vehicle to an emergency center associated with the specialized assistance server appropriate for the equipment (2); and
in which, for an emergency vehicle including at least one medical appliance for monitoring a patient and connected to the communications module (1), the communications module (1) is arranged to collect operating data supplied by the medical monitoring appliance and corresponding to vital data concerning the patient, and is arranged to transmit said data to said specialized server (5a, 5b. . . , 5n), and said specialized server (5a, 5b, . . . , 5n) is arranged to monitor the state of the patient remotely.

20-27. (canceled)

28. A communications module for implementing the method of claim 1, the module comprising collector means (11) arranged to read operating data relating to an equipment (2) to be inspected and means (17) for sending the operating data to a remote server (3, 5a, 5b, . . . , 5n), the module being characterized in that it is provided with means (13) for detecting an emergency event relating to the equipment (2) to be inspected and then, on detecting such an emergency event, for making a priority connection with a “black box” server (8) and transmitting thereto a stream of data conveying data relating to the equipment (2) to be inspected.

29-32. (canceled)
